(19) United States
(12) Patent Application Publication
(10) Pub. No.: US 2011/0268856 A1
(43) Pub. Date: Nov. 3, 2011

(54) METHOD FOR MATURING WINE AND DEVICE FOR IMPLEMENTING SAME

(76) Inventor: Michael Paetzold, La Brede (FR)

(21) Appl. No.: 13/126,870

(22) PCT Filed: Oct. 29, 2009
(86) PCT No.: PCT/FR09/52089

§ 371 Date: Jul. 8, 2011

(30) Foreign Application Priority Data
Oct. 29, 2008 (FR) 0857352

(51) Int. Cl. C12G 1/02; B01F 13/02

(52) U.S. Cl. 426/474; 99/277

(57) ABSTRACT

A method for maturing a wine contained in a container having a gaseous phase referred to as the sky mounted thereon, the container including elements for injecting a gaseous phase into the wine or a liquid phase and a circuit which extends from at least one sampling point at sky level to the injection elements in the liquid phase, and an element for the forced circulation of the gaseous phase between the sampling point and the injection elements. The method includes feeding an inert gas into the container to reduce the residual oxygen level in the sky, recirculating the gaseous phase of the sky via the forced circulation element through the liquid phase to establish a forced balance between the gaseous and liquid phases in the container, feeding oxygen into the container, and recirculating the gaseous phase of the sky via the forced circulation element through the liquid phase to retain a substantially constant residual oxygen level in the sky.

The invention relates to a process of maturing a wine as well as a device for its implementation. The invention relates more particularly to a process of wine enhancement, and especially a process of supplying oxygen during the maturing of the wine.

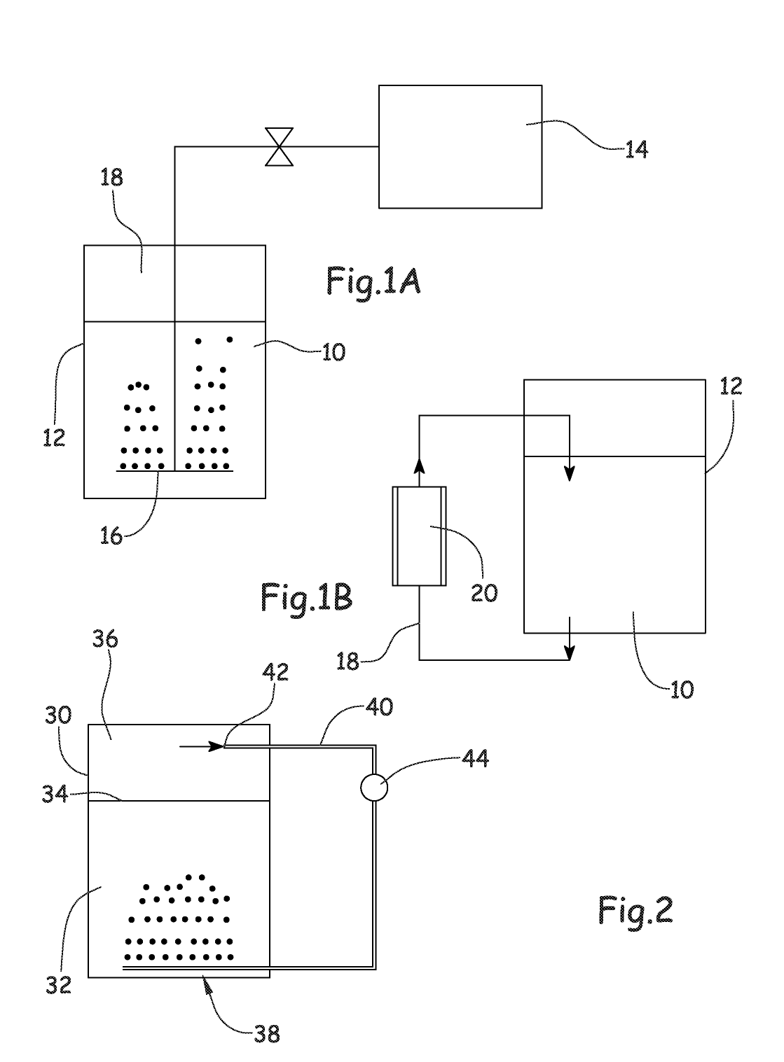

As shown in FIGS. 1A and 1B, the wine (or the must) 10 can be stored for at least part of its maturing in a stainless steel tank 12.

Tanks used for maturing wine comprise in the upper part at least one orifice for allowing introduction of the harvest, the must or different tools into the tank. In addition, the tank comprises at least one tap to allow emptying or drawing-off of part of the contained liquid. These different orifices and taps are blocked off by liquid-tight hatches or plugs which however are not gas-tight in order to limit the risk of pressurizing said tank.

A tank for maturing wine can be equipped with a device making it possible to resuspend the dregs and homogenize the contents of said tank 12. For this purpose, means of injecting an exogenous gas can be provided in the lower part of the tank.

The bubbling of an exogenous gas in the tank can also be used to obtain an oxygenation of the wine. In this case, the exogenous gas is pure oxygen or mixed with nitrogen.

According to a first oxygenation process shown in FIG. 1A, the gas originating from a reserve 14 is injected by diffusion means 16 located in the lower part of the tank 12. This process has many drawbacks.

Thus the injection of an exogenous gas into the tank requires evacuation of the undissolved gases to avoid any overpressure in the tank 12 and is therefore accompanied by a loss of volatile aroma compounds and alcohol in a considerable proportion. The result is a method of injection that is most often discontinuous and thus a series of sudden oxidations followed by reducing phases for the wine, or a maturing by stages. Moreover this operating mode leads to use of a quantity of gas to be diffused that is much greater than that actually dissolved in the wine and therefore to wasting of said gas.

According to another oxygenation process described in document FR-2629096 and illustrated in FIG. 1B, the wine 10 is circulated via pipes 18 in a liquid/gas exchanger 20 at the level of which it is enriched by exchange with an oxygen-rich gaseous mixture before being reintroduced into the tank.

This process, which can be envisioned for a specific operation such as oxygenation of a must is not suited to maturing of the wine over months which would necessitate circulation of the wine of all the tanks of the storehouse and thus considerable energy consumption, in view of the considerable volume to be circulated.

This solution also has the drawback of having the wine circulate permanently, which constitutes a technical and qualitative risk as a result of the constant stirring up and alterations due to pumps and valves.

According to one alternative solution, the liquid/gas exchanger 20 could be placed in the tank to avoid the wine leaving the tank. However, even in this case it would be necessary to provide pumps immersed in the tank or any other analogous means to move the wine into the liquid/gas exchanger 20, which would constitute increased risks of alteration.

This invention also aims to eliminate the drawbacks of the prior art by proposing a process allowing the gentle maturing of wine in a container by limiting the risk of alteration of said wine.

For this purpose, the object of the invention is a process of maturing a wine contained in a container and which is topped by a gaseous phase called the canopy, said container comprising means of injecting a gaseous phase into said wine or a liquid phase and a circuit which extends from at least one sampling point located at the level of the canopy up to said injection means located in the liquid phase, as well as means of forced circulation of the gaseous phase between said sampling point and said injection means, characterized in that it consists in introducing an inert gas into the container in order to reduce the residual oxygen level present in the canopy to cause the gaseous phase of the canopy to recirculate via the means of forced circulation through the liquid phase so as to establish a forced equilibrium between the gaseous phase and the liquid phase which are contained in the container, to introduce oxygen into the container and to have the gaseous phase of the canopy recirculate via the means of forced circulation through the liquid phase so as to maintain a residual oxygen level essentially constant at the level of the canopy.

Other characteristics and advantages will become apparent from the following description of the invention given only by way of example alone, with respect to the attached drawings in which:

FIG. 1A is a diagram illustrating an oxygenation device according to a first variant of the prior art,

FIG. 1B is a diagram illustrating an oxygenation device according to another variant of the prior art,

FIGS. 2 to 8 are diagrams illustrating different embodiments of an oxygenation device according to the invention,

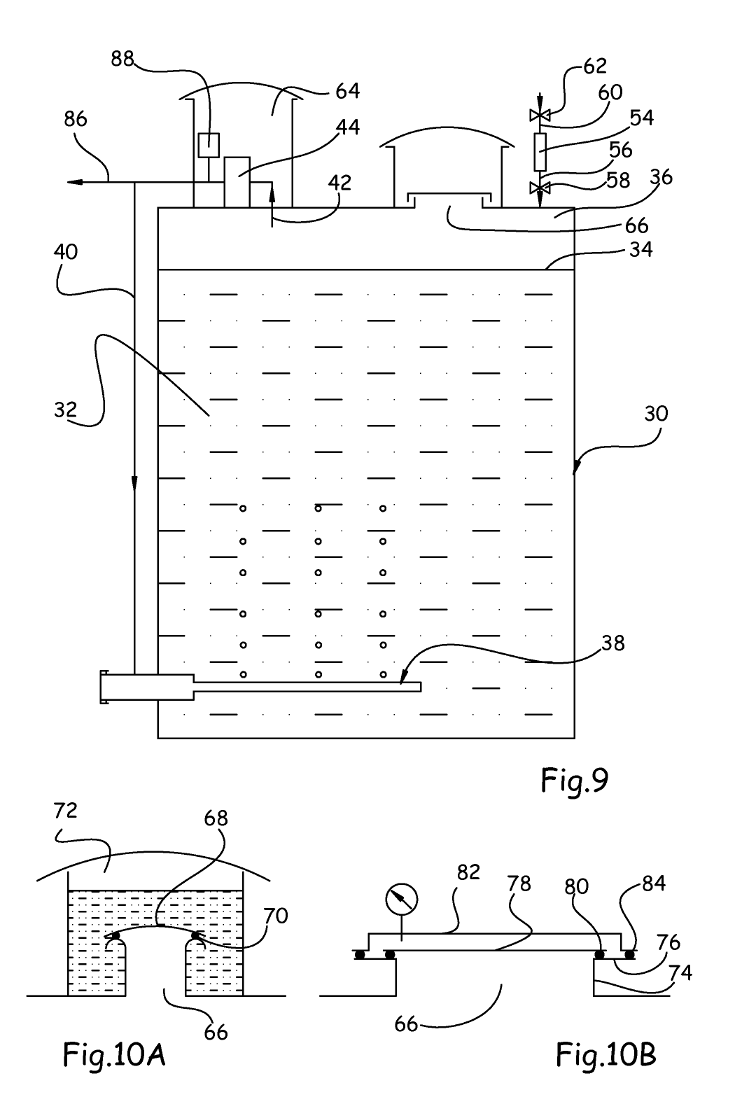

FIG. 9 is a diagram illustrating another embodiment of an oxygenation device according to the invention,

FIG. 10A is a diagram illustrating one embodiment of a hatch of an oxygenation device according to the invention,

FIG. 10B is a diagram illustrating another embodiment of a hatch of an oxygenation device according to the invention,

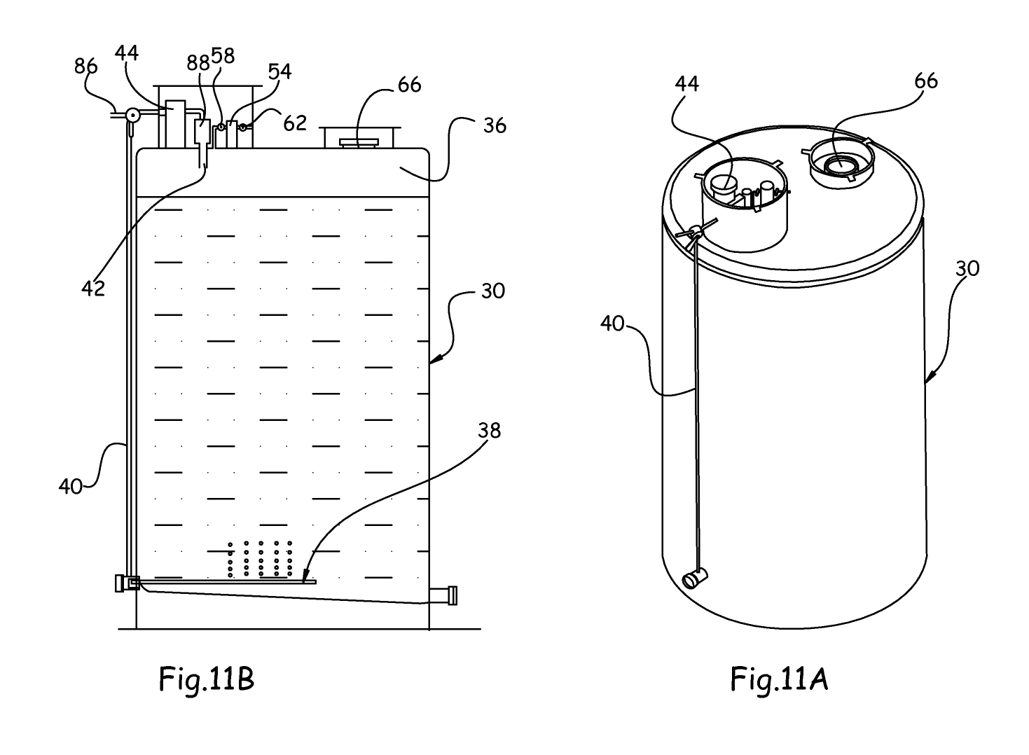

FIG. 11A is a perspective view of one embodiment of a device according to the invention, and

FIG. 11B is a section of the device of FIG. 11A.

In the different FIGS. 2 to 8, a container which is able to store a liquid is labeled 30. The container 30 can have different shapes and capacities.

According to a nonlimiting embodiment, this container 30 is made of a material able to store gas and food products. This container is generally made of several parts and comprises different openings for introducing solid or liquid elements.

By way of example, this container 30 is a stainless steel tank.

Since this invention is aimed at managing a gaseous phase that can be put into contact with a liquid, it can be applied to different phases of the production of the wine.

The wine contained in the container 30 with a surface 34 separating the liquid phase and a gaseous phase which is hereinafter called the canopy 36 located above the surface 34 is labeled 32.

For the remainder of the description, a wine is defined as a grape product at its different phases of its production. In the container the wine can comprise an accumulation of solid constituents called cap at the surface 34.

The gaseous phase of the canopy 36 is composed of gases which have been extracted from the liquid phase following a thermodynamic equilibrium and can be very difficult to re-dissolve, even if theoretically a new thermodynamic state would allow it, for want of a sufficient exchange area and/or for want of a supply of energy sufficient for crossing the energy barrier of the liquid head.

In a known manner the container 30 comprises means 38 for injecting a gas into the wine, preferably placed at the foot of the container 30.

As a variant, the means 38 for injecting a gas can be located at the level of or above the dregs.

In the case of the oxygenation of the wine, the injected gas contains oxygen and is designed to be dissolved at least partially in the wine. By way of example the injected gas can be a mixture of oxygen and nitrogen. The undissolved gas in the wine constitutes a component of the gaseous phase present at the level of the canopy 36.

According to one embodiment, these injection means 38 can comprise a tube or a perforated plate to allow passage of the gas in the form of bubbles into the wine. Preferably the injection means 38 have the form of at least one diffuser, for example a pipe with a certain porosity as a function of the diffusion of the gas into the desired wine, for example a fitted tube of stainless steel or a polyethylene tube.

This type of diffusion deriving from the porosity of a pipe in contact with the wine makes it possible to obtain a micro-oxygenation making it possible to increase the exchange surface between the injected gas and the wine and thus a better dissolution of the supply gas and a better homogenization of the wine.

In a complementary embodiment the injection means 38 can be put into motion by the action of the passage of the gas and the injection of the bubbles. Thus the injection of the gas is associated with a movement of the injection means which forces the suspension of the dregs which have accumulated in the lower part of the tank. For example, the injection means 38 have a helical or spiral or endless screw shape and are put into motion around an axis by the ejection of the gases.

Other embodiments can be foreseen for the injection means 38 and will be described below.

According to the invention the device comprises a first circuit 40 which extends from at least one sampling point 42 located above the surface 34 of the liquid up to the injection means 38 that are located in the liquid, preferably in the lower part of the liquid, as well as the means 44 of forced circulation of the gas that are provided between the sampling point 42 and the injection means 38. Depending on the case, the circuit is located inside the container or outside.

According to one embodiment the forced circulation means 44 assuring the sampling of one part of the gaseous phase of the canopy 36 and its re-introduction into the wine 32 have the form of a compressor or a pump.

Preferably the compressor is dimensioned for low flow rates and pressures such as 1 to 1000 l/min for an overpressure of 0.1 to 10 bars.

The fact of having the gaseous phase of the canopy recirculate makes it possible to limit the overpressure of the latter and possible aroma losses.

According to the invention the gaseous phase of the canopy is released in the wine, preferably at the foot of the tank, through the injection means 38 allowing the re-suspension of the dregs and homogenization of the contents of the tank 30. Preferably the injection means 38 are dynamic and put into motion by the expansion of the injected gas, the bubbles and the movement created in this way, reinforcing the re-suspension of the dregs and the homogenization of the contents of the tank 30.

According to another advantage if a supply gas is only partially dissolved in the wine, the fraction of the undissolved supply gas accumulated in the gaseous phase of the canopy 36 is again re-introduced into the wine, making it possible to resolubilize the normally lost compounds, because they have “escaped” from the wine. This leads to improving the ratio between the amount of supply gas actually consumed by the wine and that used.

Finally, according to the invention the wine does not pass through fluid pumps or circuits during possible oxygenation, which limits the risks of alterations. According to one simplified embodiment illustrated in FIG. 2, the injection means 38 can be used to obtain a counterpressure in the circuit 40 between the forced circulation means 44 and said injection means 38. For this purpose, means such as a valve can be provided to adjust the value of the counterpressure.

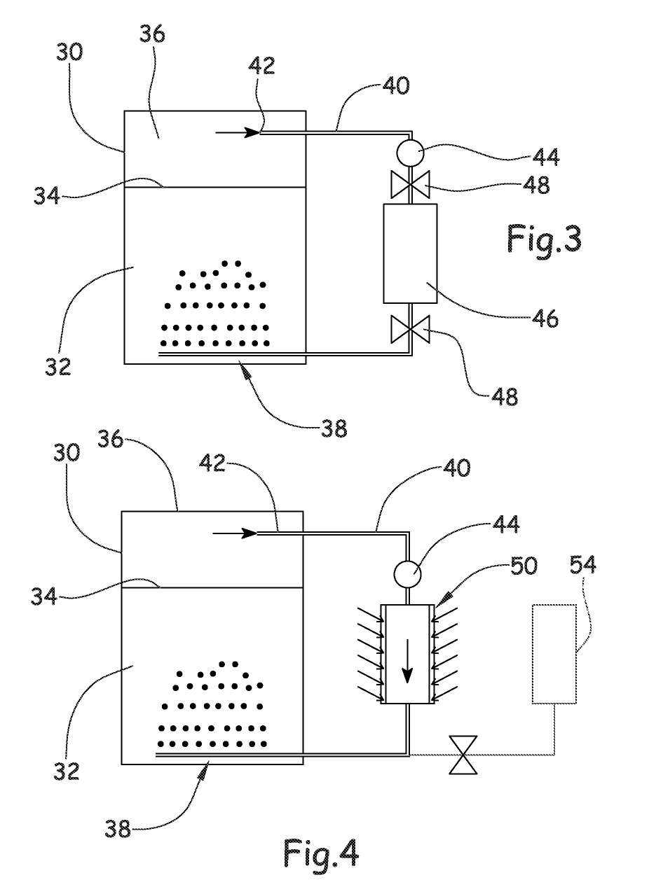

According to another embodiment shown in FIG. 3, the device comprises a reservoir 46 provided between the forced circulation means 44 and the injection means 38 for accumulating the gaseous phase up to a desired value. According to this embodiment, two valves 48, preferably solenoid valves, are placed upstream and downstream from the reservoir 46, making it possible to close respectively the intake and the output of the gaseous phase of the reservoir 46 to regulate the accumulation of the gaseous phase up to a desired value.

By way of indication, the desired pressure can vary from 0.1 to 9.5 bars, ideally from 0.2 to 4 bars.

According to the invention the device comprises means for introducing a supply gas and especially oxygen in a small amount for optionally a long interval.

According to the embodiments shown in FIGS. 4 to 8, the device comprises at least one exchanger 50 for enriching the gaseous phase in at least one component necessary for maturing the wine and/or for removing at least one component of said gaseous phase.

Preferably the device comprises means for measuring the variation of the partial pressure of the component supplied or removed at the level of the exchanger 50 as well as means for measuring the flow rate of the gaseous phase.

According to variants illustrated on FIGS. 4 to 6, the exchanger 50 is mounted in series and placed at the level of the circuit 40 between the sampling point 42 and the injection means 38, preferably after the forced circulation means 44.

According to other variants which are shown in FIGS. 7 and 8, the device can comprise a second circuit 52, separate from the circuit 40, at the level of which at least one exchanger 50 is placed to perform a supply or withdrawal at the level of the gaseous phase of the canopy 36 prior to its sampling. This arrangement corresponds to a mounting in parallel.

In contrast to the proposed solution, in document FR-2629096 the amount of energy necessary for diffusion of a supply gas into the wine is very clearly less to the extent that the volume of the gaseous phase is very clearly less than that of the wine.

Depending on the case, the exchanger 50 can be of the gas/gas or gas/liquid type. In the former case, the exchanger 50 comprises at least one wall separating two gaseous phases between which a controlled exchange between the two environments takes place. In the latter case, the exchanger 50 comprises at least one wall separating the gaseous phase of the canopy and a liquid between which controlled exchange between the two environments takes place.

According to one embodiment this exchanger 50 comprises a membrane or a thin layer of polymer that is permeable to the component to be withdrawn or supplied to the gaseous phase of the canopy 36.

Within the framework of oxygenation of the wine the forced circulation of the gaseous phase of the canopy 36 through this exchanger 50 makes it possible to establish a continuous regimen of diffusion of the oxygen into the wine over long periods.

In contrast with the processes of the prior art, the process of the invention makes it possible, starting from an initial stable state, to control the supply of oxygen as a function of its slow rate of dissolution in the wine, avoiding the irregular and sudden supplies responsible for organoleptic deterioration.

According to another advantage of the invention, the device makes it possible to separate the operation of enrichment of the wine with supply gas into two single and distinct operations, i.e., in a first step the bringing of the partial supply gas pressure of the gaseous phase of the canopy into equilibrium with that of the external environment through an exchanger 50, then in a second step, the dissolution of this supply gas in the wine by a second transfer from the gaseous phase to the wine. The separation into two single operations makes it possible to precisely control the overall enrichment of the wine/gaseous phase system by managing the partial pressure of the supply gas, outside the tank, using for example a probe for measuring the partial pressure of the supply gas in the gaseous phase between the upstream and the downstream of the exchanger 50.

According to the invention this control does not require immersion of a probe for measuring the partial pressure of the supply gas such as the oxygen dissolved in the wine. The control of the flow rate of the gaseous phase and of the variation of the partial pressure of the supply gas upstream and downstream from the exchanger thus makes it possible to precisely control the actual amount of supply gas actually dissolved in the wine.

Preferably the device comprises means for adjusting the transfer rate at the level of the exchanger 50 and controlling in this way for example the kinetics of the diffusion of the supply gas into the wine.

According to a first variant, the regulation of the transfer rate in the exchanger 50 can derive from the adjustment of the area of the exchange surface at the level of the exchanger 50. Thus according to a first variant, the exchanger 50 comprises a variable and adjustable exchange surface.

According to another variant, the regulation of the transfer rate in the exchanger 50 can derive from the adjustment of the pressure difference on either side of the exchange surface of the exchanger 50, especially from the adjustment of the difference of partial pressures of the gas to be supplied or withdrawn that is present in the gaseous phase of the canopy and of that present in the atmosphere in contact with the exchange surface.

In a nonlimiting way, the device can be used to diffuse a supply gas such as oxygen for example in the wine.

In this case, the device makes it possible to obtain self-regulation. Thus, when the wine can dissolve more oxygen, which corresponds to an oxygen requirement, the partial pressure of the oxygen of the gaseous phase of the canopy decreases. Consequently, the pressure difference at the level of the exchanger 50 on either side of the exchange surface increases, which is brought about by a more significant transfer of oxygen into the gaseous phase of the canopy at the level of said exchanger in order to meet the requirement of the wine. In contrast, when the wine can no longer dissolve oxygen, the partial pressure of the oxygen of the gaseous phase of the canopy increases. Consequently, since the difference of the oxygen partial pressure on either side of the exchange surface is smaller, the enrichment of the gaseous phase of the canopy with reinjected oxygen is reduced.

The pressure difference can be adjusted by modifying the operating regimen of the forced gas circulation means 44. As a variant, the regulation of the transfer rate in the exchanger can derive from the oxygen concentration of the environment in contact with the exchanger, the latter being placed in an enclosure with a controlled atmosphere.

However, other elements can make it possible to act on this pressure difference. Thus, the permeability levels (or the porosity level) of the diffuser and/or of the exchanger influence the supply gas transfer rate.

All of the parameters are adjusted so as to obtain a long and progressive diffusion as a function of the requirements of the wine to obtain the sought-after organoleptic characteristics of the wine. Thus, the device of the invention makes it possible to obtain a constant consumption of small amounts of dissolved oxygen by the wine.

Thus, a way will be sought to limit the amount of dissolved oxygen at each instant below a threshold that can be chosen as a function of the wine and of the chosen kinetics, for example below 0.1 mg/l.

By way of indication, for a 225 liter container, for a supply of 10 to 40 mg/1/year, it is possible to use a polyethylene film (having an oxygen permeability of 2.10⁻¹³ ml·cm⁻²·s⁻¹·pa⁻¹) with a thickness of 0.1 mm and an area of 300 to 1000 cm², a polyethylene film with a thickness of 0.01 mm and an area of 30 to 100 cm², or a silicone film (having an oxygen permeability of 400.10⁻¹³ ml·cm⁻²·s⁻¹·pa⁻¹) with a thickness of 0.1 mm and an area of 1.5 to 5 cm².

By way of indication, for a 1000 liter container, for a supply of 10 to 40 mg/1/year, it is possible to use a polyethylene film (having an oxygen permeability of 2.10⁻¹³ ml·cm⁻²·s⁻¹·pa⁻¹) with a thickness of 0.1 mm and an area of 1200 to 5000 cm², a polyethylene film with a thickness of 0.01 mm and an area of 120 to 500 cm², or a silicone film (having an oxygen permeability of 400.10⁻¹³ ml·cm⁻²·s⁻¹·pa⁻¹) with a thickness of 0.1 mm and an area of 6 to 25 cm².

As shown in FIG. 4, the device can comprise a gas supply reservoir 54 to optionally carry out an initial supply.

According to the embodiment shown in FIG. 4, the exchanger 50 assures supply gas transfer between the gaseous phase of the canopy 36 and the ambient air, the bubbling in the wine being obtained by diffusion through a pipe with permeability to the gas.

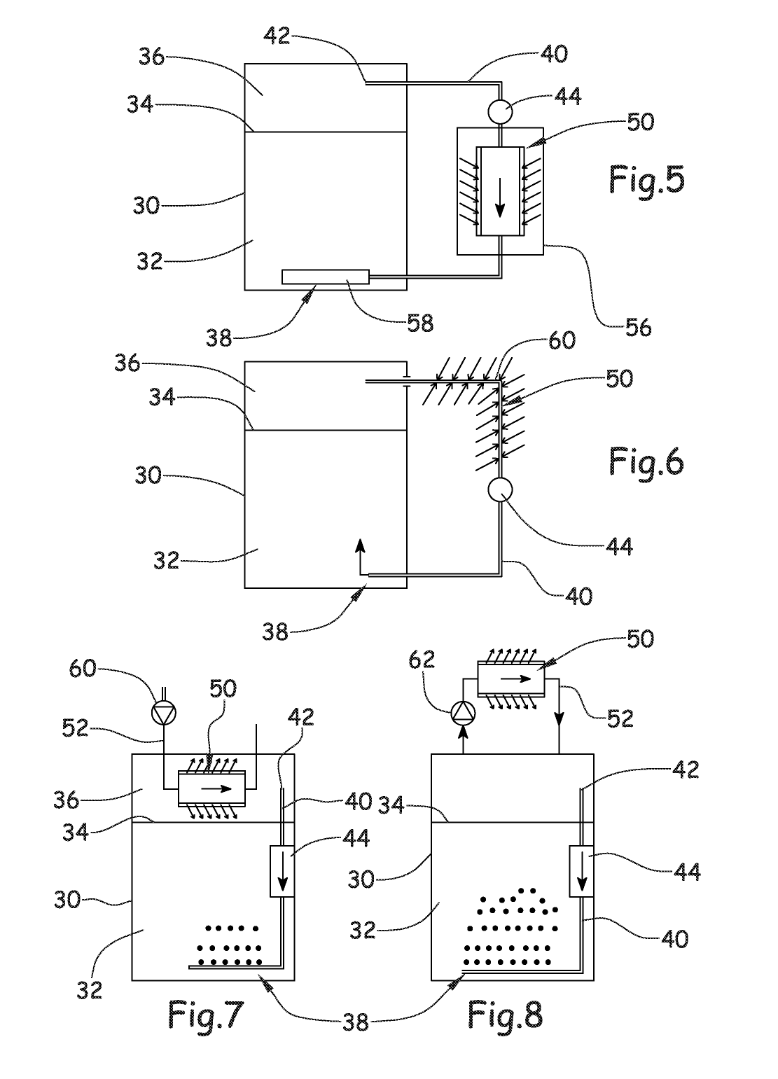

According to one embodiment shown in FIG. 5, the exchanger 50 is placed in an enclosure 56 with a controlled atmosphere containing a mixture of nitrogen and oxygen, for example with a ratio of 90/10. According to the example shown on this figure, the bubbling in the wine is obtained by diffusion through a fitted, stainless steel diffuser 58.

In FIG. 6 the device comprises means for regulating the exchange surface of the exchanger 50.

According to this embodiment, the exchanger 50 has the form of a pipe 60 with permeability to the supply gas, which extends from the sampling point 42 up to the forced circulation means 44. Said pipe can slide in a sheath that is impermeable to the supply gas to modulate the area of the exchange surface. According to one embodiment, the pipe 60 can slide at the level of an orifice provided at the level of the wall of the container, means assuring fluid-tightness between the inside and outside of the container at the level of said orifice. As a function of the requirements, the pipe 60 can be introduced farther into the container in order to reduce the exchange surface with the outside or it can be withdrawn farther from the tank to increase the exchange surface.

By way of example, if 50 mg/l/year per 1000 liters of wine are desired to be supplied through a silicone pipe 0.5 mm thick and 2 mm in diameter, it would be necessary that the length of the pipe 60 in contact with the outside be 2 m.

In FIGS. 7 and 8, the enrichment of supply gas is performed through an independent circuit of the circuit provided for sampling of the gaseous phase of the canopy and its reinjection into the wine.

According to a first variant shown in FIG. 7, the exchanger 50 is located at the level of the canopy 36. One circuit makes it possible to sample a gas outside or inside an enclosure, to have it pass through the exchanger 50 and to eject it to the outside of the container. Circulation means 60 are preferably provided to force the passage of the sampled gas into the exchanger.

According to another variant shown in FIG. 8, the exchanger 50 is located outside the container. In this case, a circuit is provided for sampling the gaseous phase of the canopy 36, for having it pass through the exchanger 50 and ejecting it into the canopy 36. Circulation means 62 are preferably provided to force the passage of the gaseous phase of the canopy into the exchanger.

The device of the invention can be used to allow slow diffusion of other gases that can be made soluble in the wine, for example SO₂ or CO₂.

In one simplified embodiment the supplied component necessary for the maturing of the wine is introduced in gaseous form directly into the gaseous phase of the canopy.

According to another aspect of the invention, the different variants shown in FIGS. 4 to 8 can be used to withdraw a component that is present in the gaseous phase, the differences of partial pressure of said component on either side of the wall or walls that are permeable to said component in the exchanger 50 being adapted to assure the transfer of said component from the gaseous phase of the canopy 36 to another environment and thus to withdraw it from the tank.

According to another embodiment, the injection means 38 can have the form of a second exchanger placed in the wine, ensuring a transfer of at least one part of the gaseous phase placed in forced circulation into the wine by the means 44. This second exchanger can comprise a porous or membrane module like the first exchanger 50. In the case of a simple diffusion, the device also comprises means of returning the gaseous phase to the canopy, for example a return pipe extending from the second exchanger and discharging into the canopy 36.

In one preferred embodiment, the device comprises means for controlling the counterpressure at the level of the injection means 38, for example a valve whose control makes it possible to go alternatively from the bubble injection mode to the simple diffusion mode. Thus, this changing of modes is effected by having the counterpressure vary respectively above or below a certain operating threshold especially of the injection means and the hydrostatic pressure of the wine in the maturing tank.

The device according to the invention makes possible, therefore, the use of two processes, either separately or jointly or alternately.

According to the first process, a fraction of the gaseous phase of the canopy of the tank is circulated by the means 44 and compressed in a reservoir 46 up to a desired value. When the latter is reached, the valve 48 located upstream is opened so as to allow the gaseous phase under pressure to pass to expand into the injection means 38 and to thus achieve homogenization of the wine including its solid constituents such as the dregs and precipitates and its gaseous constituents such as oxygen, carbon dioxide, nitrogen, sulfur dioxide and its numerous volatile constituents such as ethanol and alcohols in general, but also and especially such as the aroma compounds which are so difficult to preserve.

According to a second process, a fraction of the gaseous phase of the canopy of the tank is circulated by the means 44 through an exchanger 50 comprising a wall assuring the exchanges between said gaseous phase and an external environment rich in at least one component necessary for maturing, such as for example oxygen, before said enriched gaseous phase is at least partially reinjected into the wine. In this case, the gaseous phase is used as a vector gas of the component necessary for maturing.

By controlling the counterpressure at the level of the injection means 38 and/or by authorizing the transfer of only one part of the gaseous phase at the level of the injection means 38 and by driving the remaining part into the canopy via a return pipe, it is possible to choose between an injection mode with or without agitation.

Thus, at the start of maturing the device makes it possible to enrich the gaseous phase and re-inject it into the wine with agitation in order to improve the exchanges between the gaseous phase and the wine, to resuspend the dregs, and homogenize the contents of the tank.

The device also allows an oxygenation of the wine without agitation when it is desired to leave the dregs at rest and to no longer agitate the wine at the end of maturing, as will be detailed below.

The device of the invention can comprise an automatic device making it possible to program different wine maturing methods and assuring the control of the circulation means, of the exchanges at the level of the exchanger(s), and of the injection means.

Depending on the case, the device according to the invention can be disassembled and can be used with different tanks. In a variant, the tanks can each be equipped with a device according to the invention.

The device can comprise means of absorption and/or destruction of at least one component of the gaseous phase of the canopy, especially at the level of the circuit 40.

According to another embodiment shown in FIGS. 9, 11A and 11B, for the introduction of a supply gas, the device comprises a supply chamber 54 and means for having said supply chamber 54 alternately communicate either with the interior of the tank or with the ambient air or a supply gas reservoir. For this purpose, the supply chamber 54 is connected by a pipe 56 to the upper part of the tank at the level of which a solenoid valve 58 is provided and by a pipe 60 to the ambient air or to a reservoir (solution not shown) at the level of which a solenoid valve 62 is provided.

Advantageously the volume of the supply chamber 54 can be adjusted so as to be able to control the volume of gas introduced into the tank in one stage.

Thus, to introduce a given volume of gas (corresponding to the volume of the supply chamber), the solenoid valve 58 being in the closed state, the solenoid valve 62 is switched to the open state so as to have the supply gas penetrate into the supply chamber 54. When the supply chamber 54 is filled, the solenoid valve 62 is switched to the closed state, then the solenoid valve 58 is switched to the open state so that the gas contained in the supply chamber is mixed with the gas contained at the level of the canopy of the tank.

In practice, the volume of the canopy will represent less than 10% of the volume of the tank and the daily oxygen supply volume will be less than 0.01% of the volume of the tank.

Taking into account this low oxygen supply, it is important that the tank be relatively tight and that the different orifices, taps or supply gas introduction systems be gas-tight.

For this purpose, as shown in FIG. 9, the forced circulation means 44 and the supply gas introduction system 54 to 62 are located in at least one fluid-tight and inert enclosure 64.

In a complementary manner, the tank comprises at the level of its upper part an orifice 66 to allow introduction of the harvest, the must and different tools, said orifice 66 being blocked off by a cover equipped with reinforced, gas-tight sealing means allowing isolation of the interior of the tank from the outside atmosphere.

According to one embodiment shown in FIG. 10A, the orifice 66 is blocked off by a cover 68, a seal 70 being inserted between these two elements. To reinforce the tightness, the tank comprises an enclosure 72 covering the orifice 66 and its cover 68, both immersed into an asepticized liquid.

According to another embodiment shown in FIG. 10B, the orifice 66 is topped by a pipe 74 with a flange 76 in the upper part. To block off the orifice, a first cover 78 is provided with a peripheral seal 80 inserted between the first cover 78 and the flange 76 as well as a second cover 82 covering the first with a peripheral seal 84 inserted between said second cover 82 and the flange 76, the space provided between the two covers 78 and 82 being filled with a gas, preferably nitrogen, under controlled pressure.

To ensure an optimal oxygenation, the process comprises four successive stages.

The first initialization stage consists in introducing an inert gas into the tank using injection means 38 so as to cause the residual oxygen level in the canopy to drop to a so-called initial value. By way of example, the inert gas is pure nitrogen or a nitrogen mixture with carbon dioxide gas (80% nitrogen, 20% carbon dioxide gas). The injection of the inert gas is accomplished with a sufficient flow rate on the order of 10 l/min so that the canopy is swept during passage of the inert gas and so that the residual oxygen level of the canopy drops.

The sampling point 42 is connected to an exhaust 86 to avoid a pressurized tank. A gas analyzer 88 allows measurement of the variation of the partial pressure of the oxygen and tracking of the reduction of the residual oxygen level in the canopy 36.

When the desired residual oxygen level in the canopy is reached, for example roughly 1% of the canopy volume, the exhaust 86 is closed and the forced circulation means 44 are actuated so that the gaseous phase contained in the canopy is injected into the liquid phase so as to force the equilibrium between the two phases. The forced equilibrium is obtained after the recirculation of the gaseous phase of the canopy in the liquid phase for several minutes, roughly 20 minutes. This duration depends likewise on the flow rate of the forced circulation means 44, preferably roughly 20 l/min, on the geometry of the tank, preferably cylindrical, with a height greater than the diameter, on the injection means 38, especially on their length (preferably greater than or equal to the radius of the tank) and on their placement (preferably near the bottom, for example 100 mm from the bottom).

After this first stage, the liquid phase has a dissolved oxygen concentration that is directly proportional to the oxygen level in the canopy, so-called equilibrium. For example if the gaseous phase of the canopy comprises 1% by volume of residual oxygen, the liquid phase comprises roughly 0.4 mg/l of dissolved oxygen.

The second stage, known as maintenance, is intended to check that the system is gas-tight and that the supply of oxygen in a small amount is not going to be perturbed by a leak with the atmosphere external to the tank that can supply more oxygen than the desired supply.

During this second stage the gaseous phase of the canopy is recirculated by spaced sequences without supply and the gas analyzer 88 placed on the recirculation loop makes it possible to be confident of the stability of the oxygen level.

Preferably this recirculation is not continuous but is accomplished at regular intervals. For example, the recirculation is carried out for one minute every six hours. This stage can last 24 hours.

The third stage, known as supply, consists in introducing a given volume of oxygen into the canopy. According to variants of the devices, this stage can be carried out by having the gaseous phase of the canopy circulate in contact with a membrane that is permeable to the oxygen or by using a supply chamber 54 and a set of solenoid valves 58 and 62. Advantageously the volume of the supply chamber is roughly 0.001% of the tank volume.

Thus the supply of oxygen takes place by successive doses of a volume of roughly 0.001% of the tank volume in order to obtain a gradual oxygenation suitable for slow dissolution in the wine.

The fourth stage, known as recirculation, consists in having the gaseous phase of the canopy recirculate in the liquid phase using the injection means 38 and the forced circulation means 44. This recirculation is tied to the rate of enrichment when a membrane is used at the level of the recirculation circuit 40 for supply or it can be independent of the supply phase when a supply chamber 54 and a set of solenoid valves 58 and 62 for introducing the oxygen are used. In the latter case, a gas analyzer is provided for analyzing the composition of the gaseous phase of the canopy so as to control the recirculation or the supply of oxygen.

The recirculation and supply stages are performed in a staggered manner over time or simultaneously. The frequencies of supply and/or recirculation are adjusted so as to preserve a residual oxygen level essentially constant at the level of canopy, the so-called equilibrium level.

Preferably the checking and control means are provided to control the solenoid valves 58 and 62 and the forced circulation means 44.

Thus, when the oxygen level of the canopy decreases and the consumption rate accelerates dangerously and risks causing an aromatic deterioration, it is possible to stop or reduce the recirculation. In the opposite case, when the oxygen level of the canopy increases and the consumption rate decreases, it is possible to increase the recirculation of the gaseous phase through the liquid phase.

In contrast with the processes of the prior art, the process of the invention makes it possible, starting from an initial stable state, to control the supply of oxygen as a function of the slow rate of dissolution in the wine, avoiding irregular and sudden supplies responsible for organoleptic deteriorations.

1. Process of maturing a wine (32) contained in a container (30) and topped by a gaseous phase called the canopy (36), said container comprising means (38) of injecting a gaseous phase into said wine (32) or liquid phase and a circuit (40) which extends from at least one sampling point (42) located at the level of the canopy (36) up to said injection means (38) located in the liquid phase, as well as forced circulation means (44) of the gaseous phase between said sampling point (42) and said injection means (38), characterized in that it consists in introducing an inert gas into the container (30) in order to reduce the residual oxygen level present in the canopy (36) having the gaseous phase of the canopy (36) recirculate via the means (44) of forced circulation through the liquid phase so as to establish a forced equilibrium between the gaseous phase and the liquid phase that are contained in the container (30), introducing oxygen into the container and having the gaseous phase of the canopy (36) recirculate via the means (44) of forced circulation through the liquid phase so as to maintain a residual oxygen level essentially constant at the level of the canopy.

2. Process of maturing a wine according to claim 1, wherein prior to the oxygen supply it consists in controlling the stability of the oxygen level in the canopy (36).

3. Process of maturing a wine according to claim 2, wherein it consists in having the gaseous phase of the canopy (36) recirculate via the forced circulation means (44) through the liquid phase during spaced sequences.

4. Process of maturing a wine according to claim 1, wherein the level of residual oxygen present in the canopy is roughly 1% by volume of the canopy.

5. Process of maturing a wine according to claim 1, wherein the supply of oxygen takes place by successive doses of a volume of roughly 0.001% of the tank volume.

6. Device for implementing the process of maturing a wine according to claim 1, comprising a container able to contain wine topped by a gaseous phase called the canopy (36), said container comprising means (38) of injecting a gaseous phase into said wine (32) or liquid phase and a circuit (40) which extends from at least one sampling point (42) located at the level of the canopy (36) up to said injection means (38) located in the liquid phase, as well as means (44) of forced circulation of the gaseous phase between said sampling point (42) and said injection means (38), characterized in that it comprises means for measuring the level of residual oxygen contained in the canopy (36), means for introducing the oxygen into the container and checking and controlling means for controlling said forced circulation means (44) and said means for introducing the oxygen as a function of the measured level of residual oxygen contained in the canopy.

7. Device for maturing wine according to claim 6, wherein the means for introducing the oxygen comprise a supply chamber (54) and means for having said supply chamber (54) alternately communicate either with the interior of the tank or with the ambient air or a supply gas reservoir.

8. Device for maturing wine according to claim 7, wherein the supply chamber (54) is connected by a pipe (56) to the upper part of the tank at the level of which a solenoid valve (58) is provided and by a pipe (60) to the ambient air or to a reservoir at the level of which a solenoid valve (62) is provided.

9. Device for maturing wine according to claim 7, wherein the supply chamber (54) has an adjustable volume.

10. Device for maturing wine according to claim 6, wherein it comprises at least one inert and fluidtight enclosure, in which the forced circulation means (44) and the means for introducing the oxygen are located.

11. Device for maturing wine according to claim 6, wherein the means for introducing the oxygen comprise at least one exchanger (50) assuring the transfer of the oxygen between the gaseous phase of the canopy (36) and an environment and comprising an exchange surface that is permeable to the oxygen against which the gaseous phase of the canopy flows.

12. Device for maturing wine according to claim 6, wherein the container (30) comprises in the upper part an orifice (66) blocked off by a cover equipped with reinforced, gas-tight sealing means.

13. Device for maturing wine according to claim 8 wherein the supply chamber (54) has an adjustable volume.

14. Device for maturing wine according to claim 7, wherein it comprises at least one inert and fluidtight enclosure, in which the forced circulation means (44) and the means for introducing the oxygen are located.

15. Device for maturing wine according to claim 8, wherein it comprises at least one inert and fluidtight enclosure, in which the forced circulation means (44) and the means for introducing the oxygen are located.

16. Device for maturing wine according to claim 9, wherein it comprises at least one inert and fluidtight enclosure, in which the forced circulation means (44) and the means for introducing the oxygen are located.

17. Device for maturing wine according to claim 7, wherein the container (30) comprises in the upper part an orifice (66) blocked off by a cover equipped with reinforced, gas-tight sealing means.
